(19) United States
(12) Patent Application Publication
(10) Pub. No.: US 2023/0087169 A1
(43) Pub. Date: Mar. 23, 2023

(54) SWITCHABLE WHEEL VIEW MIRRORS

(71) Applicant: Motional AD LLC, Boston, MA (US)

(72) Inventors: Nijumudheen Muhassin, Pittsburgh, PA (US); Jayesh Dwivedi, Pittsburgh, PA (US); Yew Kwang Low, Singapore (SG)

(21) Appl. No.: 17/448,422

(22) Filed: Sep. 22, 2021

(51) Int. Cl. B60R 1/08; B60R 1/02; B60R 1/12; B60R 1/00

(52) U.S. Cl. CPC B60R 1/08; B60R 1/025; B60R 1/12; B60R 1/002; B60R 2001/1253; B60R 2001/1223

(57) ABSTRACT

Provided are systems for switchable wheel view mirrors, which can selectively provide views of one or more wheels of a vehicle to, for example, check for obstructions. A system for a switchable wheel view mirror can include an image sensor coupled to a vehicle, a reflective surface, and an actuator. The image sensor can capture an image within a field of view of the image sensor. The reflective surface can be coupled to the actuator which moves the reflective surface between a first position and a second position. In the first position, a view of at least a portion of a wheel of the vehicle is visible within the reflective surface and the reflective surface is disposed at least partially within the field of view of the image sensor. Methods and computer program products are also provided.

### BACKGROUND

Vehicles with autonomous systems are becoming more common. Such vehicles often use a plurality of sensors that provide data that is processed to facilitate navigation thereof. The plurality of sensors may generally be configured to provide data based on the environment around the vehicle, for example, in front of, behind, and to the right and left of the vehicle. Still, detection of objects below the car, for example, around the wheels of the vehicle can be difficult and complicated.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of one or more systems of a vehicle including switchable wheel view mirrors;

FIG. 6A is a diagram of an embodiment of a switchable wheel view mirror assembly illustrated with a reflective surface thereof in a first position;

FIG. 6B is a diagram of the switchable wheel view mirror assembly of FIG. 6A illustrated with the reflective surface thereof in a second position;

FIG. 7A is a side view of a front portion of a vehicle including a switchable wheel view mirror assembly illustrated with a reflective surface thereon in a first position;

FIG. 7B is a side view of the front portion of the vehicle of FIG. 7A including the switchable wheel view mirror assembly illustrated with the reflective surface thereof in a second position;

FIG. 8A is a plan view diagram of components of a vehicle including switchable tire view mirror assemblies;

FIG. 8B is a plan view diagram of components of the vehicle of FIG. 8A including switchable tire view mirror assemblies;

FIG. 8C is a side view diagram of components of the vehicle of FIG. 8A including switchable tire view mirror assemblies;

FIG. 9A is an example image captured with an image sensor of a forward-facing camera on a vehicle including switchable wheel view mirror assemblies;

FIG. 9B is an example image captured with the image sensor of the forward-facing camera of the vehicle of FIG. 9A illustrated with the switchable wheel view mirror assemblies in a deployed position which includes a reflected view of wheels of the vehicle;

FIG. 9C is an example image captured with the image sensor of the forward-facing camera of the vehicle of FIG. 9A illustrated with the switchable wheel view mirror assemblies in a deployed position which includes a reflected view of an object positioned in front of one of the wheels of the vehicle;

FIG. 10 is a flowchart of an embodiment of a process for switchable wheel view mirrors; and

FIG. 11 is a flowchart of another embodiment of a process for switchable wheel view mirrors.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships, or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

Introduction to Switchable Wheel View Mirrors

In some aspects and/or embodiments, systems, methods, and computer program products described herein include and/or implement switchable wheel view mirrors. Switchable wheel view mirrors can be used in conjunction with cameras on the vehicle to provide views of areas around the wheels of a vehicle, for example, to monitor the wheels for objects or obstructions. Switchable wheel view mirrors can be included on vehicles that include autonomous systems that enable fully autonomous, highly autonomous, or semi-autonomous driving or navigation. Switchable wheel view mirrors can also be included on other types of vehicles, including non-autonomous vehicles or vehicles that do not include autonomous systems.

In some embodiments, systems that include switchable wheel view mirrors can include an image sensor for capturing an image and one or more switchable wheel view mirror assemblies. The image sensor can be a component of a camera positioned on a vehicle. In some embodiments, the camera can be a wide-angle camera. In some embodiments, the image sensor and/or the camera is positioned such that it captures a generally forward-facing or generally rearward-facing view from the vehicle. The one or more switchable wheel view mirror assemblies can be configured to move a reflective surface from a position generally outside of a field of view of the image sensor to a position generally within the field of view of the image sensor. The reflective surface can be positioned such that when positioned generally within the field of view of the image sensor, a reflected view of at least a portion wheel of the vehicle is visible within the field of view of the image sensor, allowing the image sensor to capture an image that includes at least a portion of the wheel. The image can then be analyzed to determine whether there are any objects positioned in proximity to the wheel (e.g., objects that could be hit by the wheel during motion of the vehicle. In some embodiments, if objects are detected, motion of the vehicle can be prohibited, for example, until the object is removed. In some embodiments, if objects are not detected, motion of the vehicle is permitted. In this way, using the switchable wheel view mirrors, objects positioned around the wheels of the vehicle can be checked for using images sensors of cameras positioned on the vehicle that would generally otherwise not be able to capture images of the wheels of the vehicles (e.g., the image sensors of the forward-facing or rearward-facing cameras).

As an example, a system for providing a view of at least a portion of one or more wheels of a vehicle can include an image sensor, a reflective surface, and an actuator. The image sensor can be coupled to a vehicle, and the image sensor can be configured to capture an image within a field of view of the image sensor. The reflective surface can be coupled to the actuator. The actuator can be coupled to the vehicle. The actuator can be configured to configured to move the reflective surface between a first position and a second position. In the first position, a view of at least a portion of a wheel of the vehicle is visible within the reflective surface, and the reflective surface is disposed at least partially within the field of view of the image sensor. Thus, the first position can be considered a deployed position of the reflective surface. The actuator can further be configured to move the reflective surface to the second position. In the second position, the reflective surface can be positioned substantially within a body panel of the vehicle and/or the reflective surface may not be substantially visible within the field of view of the image sensor.

As another example which uses switchable wheel view mirrors, a method for selectively viewing at least a portion of a wheel of a vehicle can include moving a reflective surface to a first position from a second position. In the first position, the reflective surface can be positioned within a field of view of an image sensor coupled to a vehicle such that a reflected view of at least a portion of a wheel of the vehicle is visible on the reflective surface within the field of view of the image sensor. The method can also include capturing an image with the image sensor. The method can additionally include analyzing the image to determine a location and an object type of an object relative to the wheel of the vehicle. The method can also include determining whether motion of the vehicle is permitted based on the type of the object and a location of the object relative to the wheel of the vehicle. In some embodiments, the method can be stored as instructions in a non-transitory storage media. The instructions can be configured to cause a processor to execute the method.

Accordingly, switchable wheel view mirrors can be used in a vehicle in combination with the image sensors associated with a forward-facing camera, a rearward facing camera, or other cameras on the vehicle to monitor the wheels of the vehicles for obstructions. For example, prior to driving, a reflective surface coupled to the vehicle can be moved into the field of view of the forward-facing wide camera of the vehicle and positioned such that a view of the wheel is visible within the camera's image. The image can be analyzed to check for obstructions prior to enabling motion of the vehicle. Reflective surfaces can be positioned on the vehicle in different locations to provide views of the front and/or back wheels.

The switchable wheel view mirrors can be referred to as “switchable” because, in some embodiments, they include reflective surfaces that are configured to move selectively between at least two positions. The two positions can, in some embodiments, be (1) a deployed position, an extended position, or a position that otherwise generally or substantially positions the reflective surface within a field of view of an image sensor, and (2) a concealed, a hidden position, a retracted position, or a position that otherwise positions the reflective surface generally or substantially outside of a field of view of an image sensor.

By virtue of the implementations of systems, methods, and computer program products described herein, techniques for switchable wheel view mirrors can provide one or more of the following advantages. The switchable wheel view mirrors can allow for objects positioned around wheels of a vehicle to be detected. Advantageously, switchable wheel view mirrors can allow for such detection without needing to include additional or dedicated sensors for detecting objects located around the wheels. Rather, by selectively positioning reflective surface in the field of view of an image sensor which may already be included on the vehicle for other purposes (e.g., forward- or rearward-facing cameras), such an image sensor can capture a reflected image of an area around the wheels on the reflective surfaces.

This, itself, can be advantageous for several reasons. For one, this can improve vehicle safety by, for example, preventing or reducing the likelihood that objects positioned in proximity to the wheel are contacted (e.g., run over) by the wheels when the vehicle is set into motion. Vehicle safety in this context can be particularly relevant to vehicles that include autonomous systems for controlling or driving the vehicle. In some embodiments, such systems allow the vehicle to be operated without a human driver. Without a human driver, there may be no one available to check around the wheels of the vehicle prior to beginning driving. Accordingly, it likely is beneficial for the autonomous system to be able to check monitor the area around the wheels of the vehicle prior to driving to avoid accidents, which can cause damage to life, property, or the vehicle itself. Accordingly, switchable wheel view mirrors can improve vehicle safety.

As another, because existing image sensors can be used, overall complexity of the vehicle as well as the component systems thereof can be reduced. For example, less overall sensors need be included because dedicated wheel monitoring sensors are not required. This can advantageously reduce the overall cost associate with a vehicle, while still providing desired performance. The reduction in complexity can further extend to facilitating or simplifying the maintenance of the vehicle. For example, because less sensors need be included, maintenance costs associated with the sensors can also be reduced.

Additionally, the processing power or load required to process data associated with wheel monitoring can be reduced. For example, if dedicated sensors are used to monitor the wheels, each wheel may be monitored by at least one sensor, and each sensor will produce data that will need to be processed to determine whether wheel obstructions are present. This is in addition to processing that would already be required to process data gathered by the forward-facing and/or rearward facing cameras. With switchable wheel view mirrors, dedicated sensors can be omitted, and wheel monitoring can be accomplished by processing data form the forward-facing and/or rearward facing cameras, which was likely already being processed. Thus, this can result in a significant decrease in the processing power or load required for wheel monitoring.

Accordingly, some embodiments including switchable wheel view mirrors as described herein can result in reduction of cost, reduction of complexity, and/or reduction in processing load, while also improving vehicle safety, among other advantages. The switchable wheel view mirrors can advantageously be used with vehicles including autonomous systems and are also useful and advantageous in vehicles that do not include autonomous systems.

General Overview of Vehicles Including Autonomous Systems

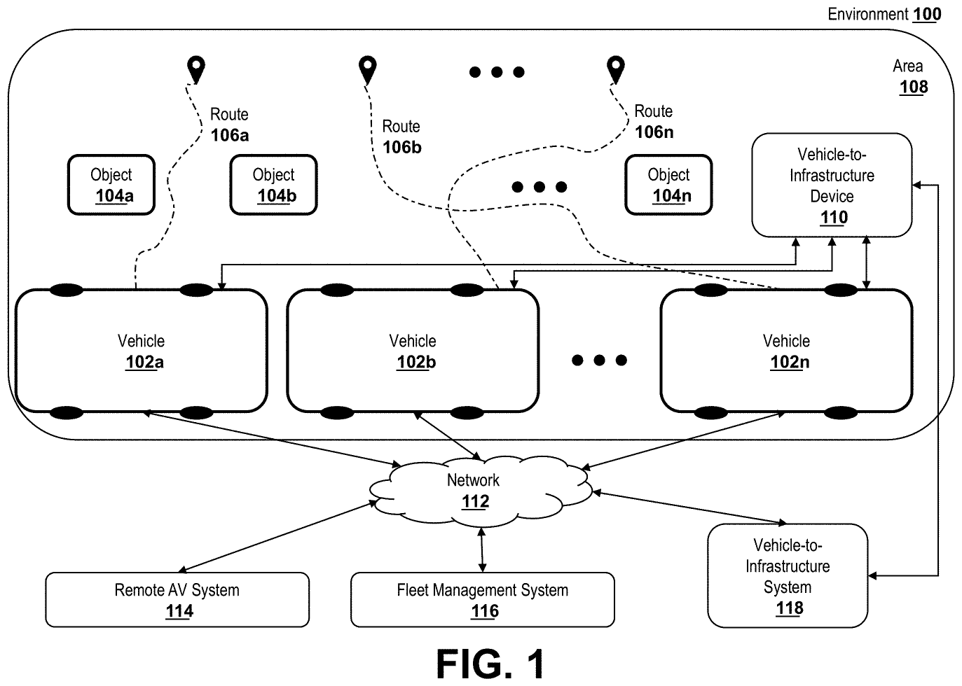

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

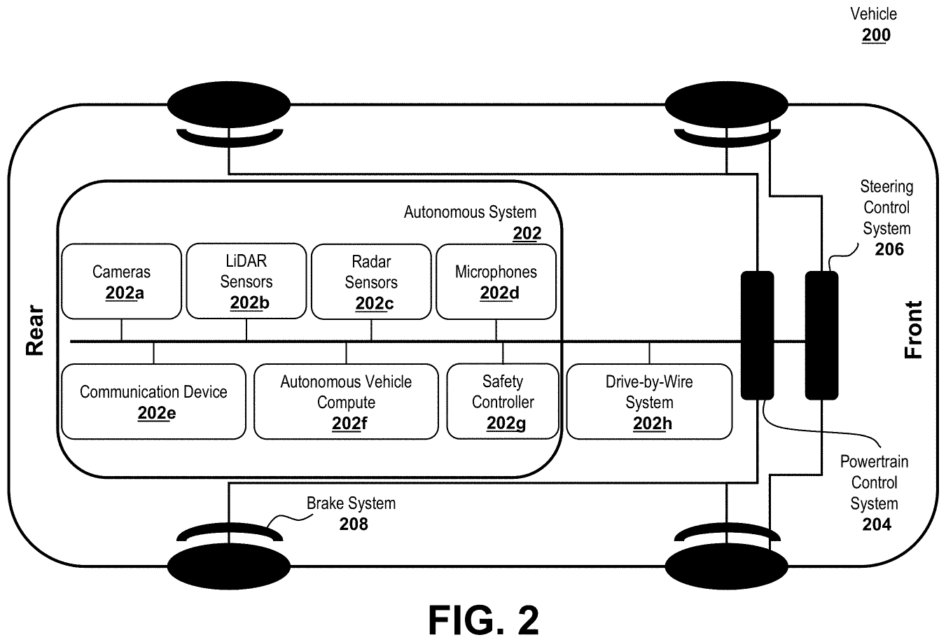

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high-level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high-level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 may have autonomous capability (e.g., implement at least one function, feature, device, and/or the like that enables vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

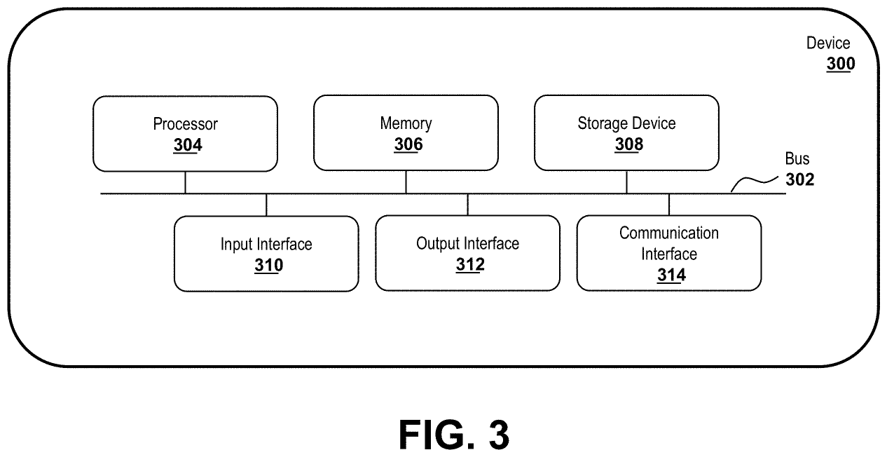

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

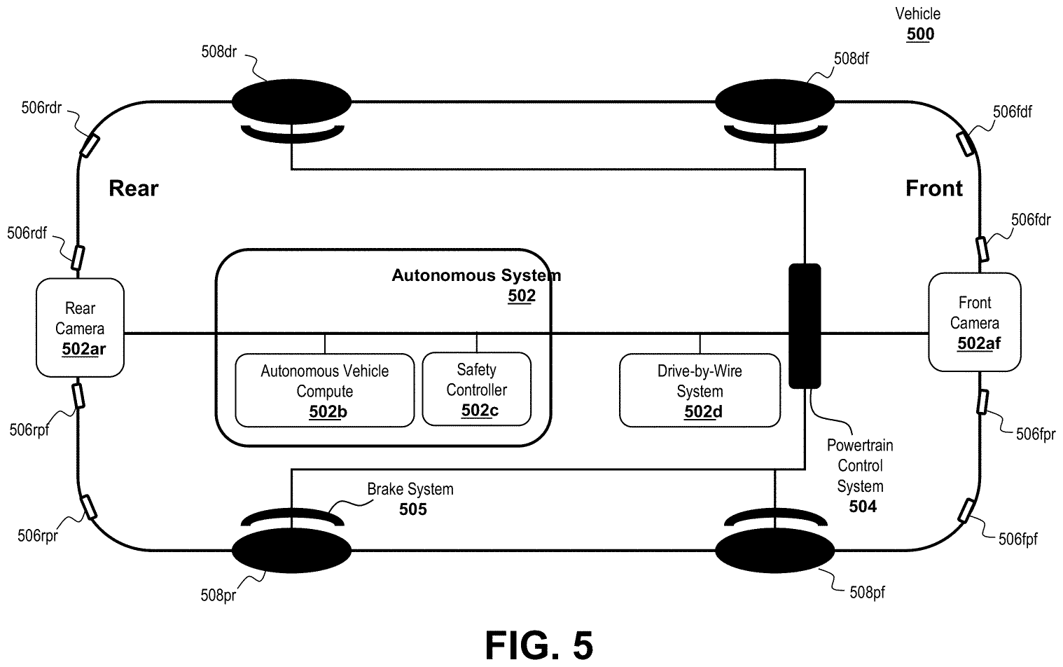

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of vehicle 200 (e.g., at least one device of a system of vehicle 200), at least one device of vehicle 500 of FIG. 5 (e.g., at least one device of a system of vehicle 500), which is described below, at least one device of other vehicles as described throughout this application, and/or one or more devices of network 112 (e.g., one or more devices of a system of network 112). In some embodiments, one or more devices of vehicles 102 (e.g., one or more devices of a system of vehicles 102), one or more devices of vehicle 200 (e.g., at least one device of a system of vehicle 200), at least one device of vehicle 500 of FIG. 5 (e.g., at least one device of a system of vehicle 500), which is described below, at least one device of other vehicles as described throughout this application, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid-state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

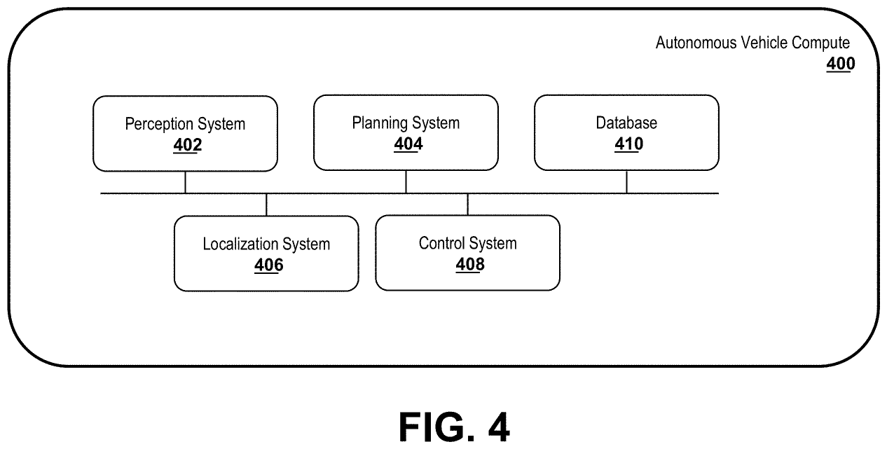

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Switchable Wheel View Mirrors

Detecting objects around a vehicle can reduce the likelihood of injury and damage, thereby improving vehicle safety. However, it can be difficult to effectively detect objects around a car. While many sensors can be placed around the vehicle to detect objects, using increasingly more sensors can increase engineering complexity, material costs, and manufacturing costs.

As described herein, switchable wheel view mirrors can be used on vehicles to augment the field of view of one or more image sensors. For example, a switchable wheel view mirror can provide (e.g., can selectively provide) views of a wheel of a vehicle to an image sensor that would generally otherwise be unable to capture images of the wheel. Accordingly, switchable wheel view mirrors can be used in conjunction with cameras and images sensors on a vehicle to provide wheel monitoring functionality.

The switchable wheel view mirrors described herein can provide an efficient solution for monitoring the wheels of the vehicle. For example, in some cases, front and rear cameras (which can be wide angle cameras) can be used to view the front and back of each tire by incorporating switchable wheel view mirrors that include reflective surfaces positioned to deflect part of the field of view of the cameras to provide respective views of each wheel to detect objects near the tire prior permitting motion of the vehicle.

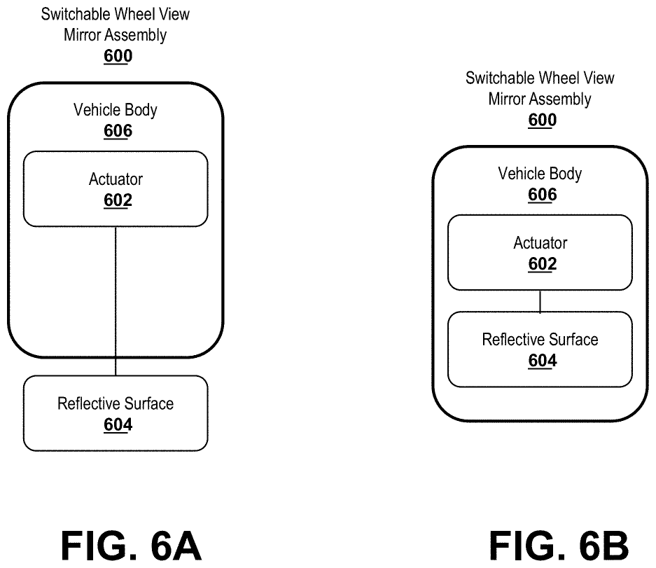

FIG. 5 is a diagram of one or more systems of a vehicle 500. The vehicle 500 may, in some cases, be the same or similar to any of the vehicles 102 of FIG. 1 or the vehicle 200 of FIG. 2. As shown in the illustrated embodiment, the vehicle 500 includes a plurality of switchable wheel view mirror assemblies 506, among other components and systems. As will be described in more detail below, with continued reference to FIG. 5, as well as with reference to FIGS. 6A-11, the switchable wheel view mirror assemblies 506 can be configured to allow for monitoring of an area around or in proximity to wheels 508 of the vehicle 500.

As shown in FIG. 5, the vehicle 500 includes an autonomous system 502, a powertrain control system, and a brake system 505. In some cases, vehicle 500 may have autonomous capability (e.g., the capability to implement at least one function, feature, device, and/or the like that enables vehicle 500 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like).

In the illustrated embodiment, autonomous system 502 includes cameras 502a (such as the illustrated front camera 502af and rear camera 502ar), autonomous vehicle compute 502b, safety controller 502c, and drive by wire system 502d. In some cases, the autonomous system 502 may be the same or similar to the autonomous system 502. In some cases, cameras 502a, autonomous vehicle compute 502b, safety controller 502c, and drive by wire system 502d can be the same or similar to cameras 202a, autonomous vehicle compute 202f, safety controller 202g, and DBW system 202h, respectively.

Cameras 502a (such as the illustrated front camera 502af and rear camera 502ar) each can include at least one device configured to be in communication with other components of the autonomous system 502 or other systems or components of the vehicle 500 through a bus (e.g., a bus that is the same as or similar to bus 302 of FIG. 3). Cameras 502a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some cases, cameras 502a generate camera data as output. The camera data may be captured by an image sensor associated with each camera 502a. In some examples, cameras 502a generate camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like).

In the illustrated embodiment, cameras 502a include a front camera 502af and a rear camera 502ar. In some cases, one or more of these cameras 502a can be omitted. For example, in some cases, the vehicle 500 includes front camera 502af but does not include rear camera 502ar. The front camera 502af is positioned on the vehicle 500 at a position that allows the image sensor of the front camera 502af to capture a generally forward-facing view (e.g., from the point of view of the car). The image sensor of the front camera 502af has a field of view (which may be derived at least partially from a lens or lens system associated with the front camera 502af) within which the forward-facing view can be captured. In some cases, front camera 502af can include a wide field of view (e.g., a wide-angle lens, a fish-eye lens, a lens having a viewing angle of approximately or greater than 120 degrees, 150 degrees, 180 degrees, 190 degrees, 200 degrees, 210 degrees, 220 degrees or more, and/or the like).

As shown in FIG. 5, in some cases, the front camera 502af is positioned on the front of the vehicle 500. For example, the front camera 502af can, in some cases, be positioned on or in a front bumper, front grill, front undercarriage, or other frontal region of the vehicle 500.

The rear camera 502ar is positioned on the vehicle 500 at a position that allows the image sensor of the front camera 502ar to capture a generally rearward-facing view (e.g., from the point of view of the car). The image sensor of the rear camera 502ar has a field of view (which may be derived at least partially from a lens or lens system associated with the camera 502ar) within which the rearward-facing view can be captured. In some cases, rear camera 502ar can include a wide field of view (e.g., a wide-angle lens, a fish-eye lens, a lens having a viewing angle of approximately or greater than 120 degrees, 150 degrees, 180 degrees, 190 degrees, 200 degrees, 210 degrees, 220 degrees or more, and/or the like). As shown in FIG. 5, in some cases, the rear camera 502ar is positioned on the rear of the vehicle 500. For example, the rear camera 502ar can, in some cases, be positioned on or in a rear bumper, rear panel, rear undercarriage, or other rear region of the vehicle 500.

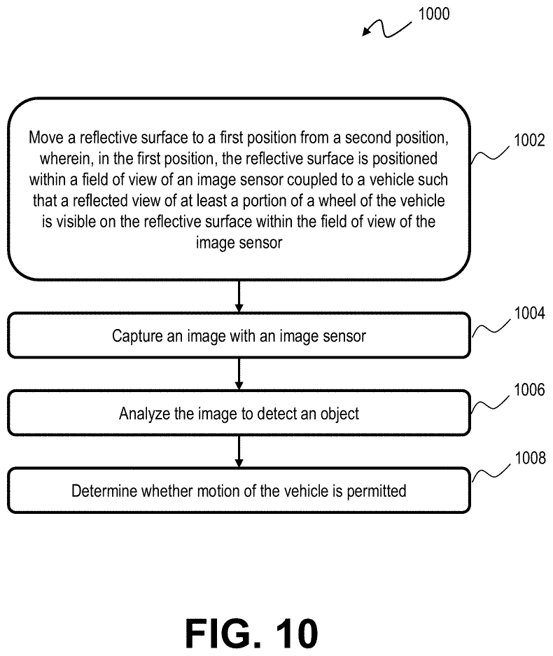

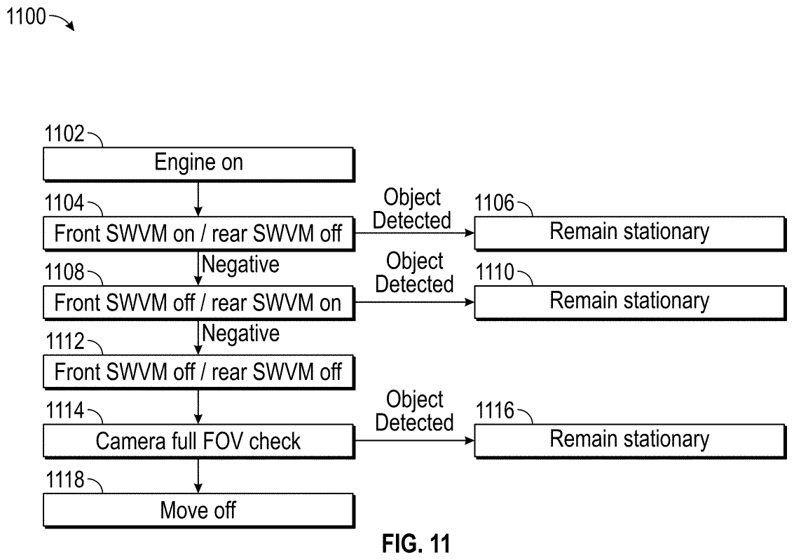

Autonomous vehicle compute 502b can include at least one device configured to be in communication with cameras 502a, safety controller 502c, and/or DBW system 502h, as well as other components such as the switchable wheel view mirror assemblies 506. In some cases, autonomous vehicle compute 502b is the same as or similar to autonomous vehicle compute 400, described above. Additionally, or alternatively, in some cases autonomous vehicle compute 502b is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1). In some cases, autonomous vehicle compute 502b can be configured to control functionality of the switchable wheel view mirror assemblies 506 and/or to receive and/or image data from front and/or rear cameras 502af, 502ar to implement the methods associated with the switchable wheel view mirrors described herein (e.g., routines 1000, 1100 of FIGS. 10 and 11, respectively, among others).

Safety controller 502c includes at least one device configured to be in communication with cameras 502a, autonomous vehicle compute 502b, and/or DBW system 502h, as well as other components such as the switchable wheel view mirror assemblies 506. In some examples, safety controller 502c includes one or more processors or controllers (electrical controllers, electromechanical controllers, and/or the like) that are configured to generate and/or transmit control signals to operate one or more devices of vehicle 500 (e.g., powertrain control system 504, brake system 505, and/or the like). In some cases, safety controller 502c is configured to generate control signals that take precedence over (e.g., override) control signals generated and/or transmitted by autonomous vehicle compute 502b. In some cases, safety controller 502c can be configured to control functionality of the switchable wheel view mirror assemblies 506 and/or to receive and/or image data from front and/or rear cameras 502af, 502ar to implement the methods associated with the switchable wheel view mirrors described herein (e.g., routines 1000, 1100 of FIGS. 10 and 11, respectively, among others).

DBW system 502d includes at least one device configured to be in communication autonomous vehicle compute 502b. In some examples, DBW system 502d includes one or more controllers (e.g., electrical controllers, electromechanical controllers, and/or the like) that are configured to generate and/or transmit control signals to operate one or more devices of vehicle 500 (e.g., powertrain control system 504, brake system 505, and/or the like). In some cases, DBW system 502d may control and/or be used to implement one or more steps in the methods associated with the switchable wheel view mirrors described herein (e.g., routines 1000, 1100 of FIGS. 10 and 11, respectively, among others). For example, in the event that an object in proximity to one of the wheels 508 of the vehicle 500, DBW system 502d may generate and/or transmit control signals to the powertrain control system 504 and/or the brake system 505 that prevent, prohibit, or restrict motion or movement of the vehicle 500. Similarly, in the event that no object is detected in proximity to one of the wheels 508 that would cause an issue with movement of the vehicle 500, DBW system 502d may generate and/or transmit control signals to the powertrain control system 504 and/or the brake system 505 that allows or permits motion or movement of the vehicle 500.

Powertrain control system 504 includes at least one device configured to be in communication with DBW system 502d. Power train control system 504 may be the same or similar to powertrain control system 504, which is described above. Brake system 505 includes at least one device configured to actuate one or more brakes to cause vehicle 500 to reduce speed and/or remain stationary.

With continued reference to FIG. 5, the vehicle 500 includes a plurality of switchable wheel view mirror assemblies 506. In the illustrated example, the vehicle 500 includes eight switchable wheel view mirror assemblies 506fdf, 506fdr, 506fpf, 506fpr, 506rdf, 506rdr, 506rpf, 506rpr (collectively referred to as switchable wheel view mirror assembles 506 and individually referred to as 506xxx, wherein: the first letter indicates whether the assembly is on the front (f) or rear (r) of the vehicle; the second letter indicates whether the assembly is on the driver (d) or passenger (p) side of the vehicle; and the third letter indicates whether the assembly provides a view of a front (f) or rear (r) wheel of the vehicle). Other numbers of switchable wheel view mirror assemblies 506 can be used in other cases. Each of the switchable wheel view mirror assemblies 506 is configured to provide a reflected view of one of the wheels 508 of the vehicle 500. In the illustrated embodiment, the vehicle 500 include four wheels 508df, 508pf, 508dr, 508pr (collectively referred to as wheels 508 and individually referred to as 508xx, wherein: the first letter indicates whether the wheel is on the front (f) or rear (r) of the vehicle, and the second letter indicates whether the wheel is on the driver (d) or passenger (p) side of the vehicle).

Accordingly, in the illustrated embodiment, (1) switchable wheel view mirror assembly 506fdf is positioned on the front, driver side of the vehicle and provides a view of the front driver side wheel 508df; (2) switchable wheel view mirror assembly 506fdr is positioned on the front, driver side of the vehicle and provides a view of the rear driver side wheel 508dr; (3) switchable wheel view mirror assembly 506fpf is positioned on the front, passenger side of the vehicle and provides a view of the front passenger side wheel 508pf; (4) switchable wheel view mirror assembly 506fpr is positioned on the front, passenger side of the vehicle and provides a view of the rear passenger side wheel 508pr; (5) switchable wheel view mirror assembly 506rdf is positioned on the rear, driver side of the vehicle and provides a view of the front driver side wheel 508df; (6) switchable wheel view mirror assembly 506rdr is positioned on the rear, driver side of the vehicle and provides a view of the rear driver side wheel 508dr; (7) switchable wheel view mirror assembly 506rpf is positioned on the rear, passenger side of the vehicle and provides a view of the front passenger side wheel 508pf; and (8) switchable wheel view mirror assembly 506rpr is positioned on the rear, passenger side of the vehicle and provides a view of the rear passenger side wheel 508pr.

In some cases, the switchable wheel view mirror assemblies 506 on the front of the vehicle 500 (e.g., switchable wheel view mirror assemblies 506fdf, 506fdr, 506fpf, 506fpr) are each configured to provide a reflected view of a corresponding one the wheels 508 (e.g., wheels 508df, 508dr, 508pf, 508pr) that is visible within a field of view of the image sensor of the front camera 502af. In some cases, the switchable wheel view mirror assemblies 506 on the front of the vehicle 500 are each configured to provide a reflected view of a front portion (e.g., a portion of the wheels 508 visible from a position in front of the vehicle 500 looking back towards the front of the vehicle 500).

In some cases, the switchable wheel view mirror assemblies 506 on the rear of the vehicle 500 (e.g., switchable wheel view mirror assemblies 506rdf, 506rdr, 506rpf, 506rpr) are each configured to provide a reflected view of a corresponding one of the wheels 508 (e.g., wheels 508df, 508dr, 508pf, 508pr) that is visible within a field of view of the image sensor of the front camera 502af. In some cases, the switchable wheel view mirror assemblies 506 on the rear of the vehicle 500 are each configured to provide a reflected view of a rear portion (e.g., a portion of the wheels 508 visible from a position behind the vehicle 500 looking back towards the rear of the vehicle 500).

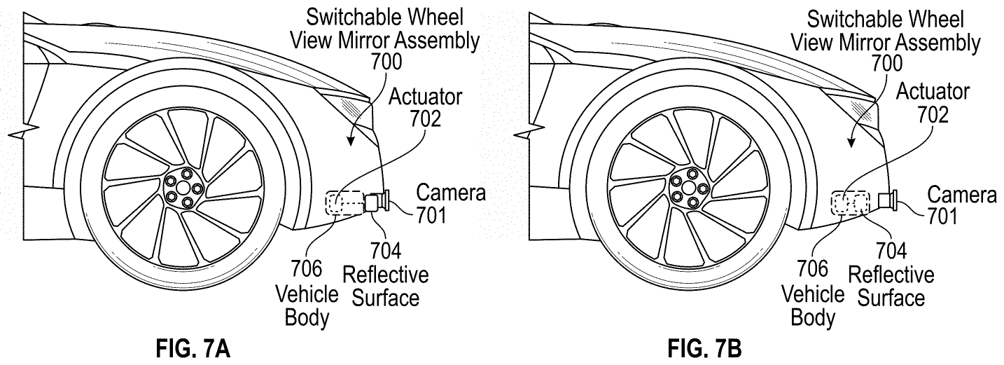

In some cases, the switchable wheel view mirror assemblies 506 are configured to move selectively between at least two positions. The two positions can include a first position, which can be a deployed position, an extended position, or a position that otherwise generally or substantially positions the reflective surface within a field of view of an image sensor. The two positions can also include a second position, which can be a concealed position, a hidden position, a retracted position, or a position that otherwise positions the reflective surface generally or substantially outside of a field of view of an image sensor. These positions will be explained in greater detail below with reference to FIGS. 6A, 6B, 7A, and 7B.

FIGS. 6A and 6B are diagrams of an embodiment of a switchable wheel view mirror assembly 600. The switchable wheel view mirror assembly 600 may be the same or similar to any of the switchable wheel view mirror assemblies described herein, including any of the switchable wheel view mirror assemblies 506 described above. As shown in, FIGS. 6A and 6B, the switchable wheel view mirror assembly 600 includes an actuator 602 and a reflective surface 604. The actuator 602 can be coupled to the reflective surface 604. The actuator 602 can further be coupled to the vehicle, for example, to vehicle body 606. The actuator 602 can further be configured to move the reflective surface 604 between at least a first position and a second position.

In FIG. 6A, the switchable wheel view mirror assembly 600 is illustrated in the first position, wherein the reflective surface 604 is positioned generally, substantially, or wholly outside of vehicle body 606 (see, e.g., FIG. 7A, described below). In such a position, the reflective surface 604 may be positioned such that is generally, substantially, or wholly visible within a field of view of a corresponding image sensor or camera of the vehicle. Accordingly, the first position can be considered a deployed position or an extended position.

In FIG. 6B, the switchable wheel view mirror assembly 600 is illustrated in the second position, wherein the reflective surface 604 is positioned generally, substantially, or wholly within a portion of vehicle body 606 (see, e.g., FIG. 7B, described below). In such a position, the reflective surface 604 may be positioned such that is generally, substantially, or wholly not visible within a field of view of a corresponding image sensor or camera of the vehicle. Accordingly, the second position can be considered a concealed position, a hidden position, a retracted position.

The actuator 602 can comprise any device configured to move the reflective surface 604 between the first position and the second position, such as a linear actuator, a motor (e.g., a stepper motor), etc. The actuator 602 can be configured to impart various motions on the reflective surface 604 to move the reflective surface 604 between the first position and the second position. For example, the actuator 602 can be configured to cause translation, rotation, or a combination of translation or rotation to move the reflective surface 604 between the first position. In some cases, the actuator 602 comprises a linear actuator configured to move the reflective surface 604 along a straight axis (e.g., to extend and/or retract the reflective surface 604) to move between the first and second positions. In some cases, the actuator 602 comprises a motor or other rotational actuator configured to cause the reflective surface 604 to pivot or hinge about an axis to move between the first and second positions. Other embodiments and mechanical structures are possible.

The reflective surface 604 can comprise a mirror or mirrored surface. Other reflective surfaces 604 (e.g., which are reflective but do not provide a mirrored surface) can also be used. In some cases, the reflective surface 604 can be enclosed in an encasement or protected by a cover to minimize dirt accumulation and damage when not in use. In some cases, the switchable wheel view mirror assembly 600 can include a door or cover which encloses and protects the reflective surface 604 in the second position. The door or cover can open to allow the reflective surface 604 to move therethrough to reach the first position.

In some cases, one or more lights can be positioned on, in proximity to, or around the switchable mirror view assembly to provide illumination. In some cases, the one or more lights comprise light emitting diodes (LEDs), although other forms of lights can also be used.

The vehicle body 606 can, in some cases, be configured to house the actuator 602 and to enclose or partially enclose the reflective surface 604 in the second position. In some cases, the vehicle body 606 comprises a recess configured to receive the switchable wheel view mirror assembly 600. In some cases, the vehicle body 606 comprises an opening, hole, or aperture configured to receive the switchable wheel view mirror assembly 600. In some cases, the vehicle body 606 comprises a body panel, a bumper, etc.

FIGS. 7A and 7B are side views of a front portion of a vehicle including a switchable wheel view mirror assembly 700. The switchable wheel view mirror assembly 700 may be the same or similar to any of the switchable wheel view mirror assemblies described herein, including any of the switchable wheel view mirror assemblies 506, 600 described above. In FIGS. 7A and 7B, the switchable wheel view mirror assembly 700 includes an actuator 702 and a reflective surface 704, which can be the same or similar to the actuator 602 and the reflective surface 604. The actuator 702 can be coupled to the reflective surface 704 and to vehicle body 706. The actuator 702 can further be configured to move the reflective surface 704 between at least a first position and a second position, as shown in FIGS. 7A and 7B, respectively. In FIGS. 7A and 7B, dashed lines are used to illustrate features that are positioned within the vehicle body 706, while solid lines are used to illustrate features positioned outside of the vehicle body 706.

In FIG. 7A, the switchable wheel view mirror assembly 700 is illustrated in the first position, wherein the reflective surface 704 is positioned generally, substantially, or wholly outside of vehicle body 706 (as illustrated by the solid line representation of the reflective surface 704). In such a position, the reflective surface 704 may be positioned such that is generally, substantially, or wholly visible within a field of view of a corresponding image sensor or camera 701 of the vehicle. In this position, the reflective surface 704 may provide a reflective view of a wheel of the vehicle this is visible by the image sensor of the camera 701.

In FIG. 7B, the switchable wheel view mirror assembly 700 is illustrated in the second position, wherein the reflective surface 704 is positioned generally, substantially, or wholly within a portion of vehicle body 706 (as illustrated by the dashed line representation of reflective surface 704). In such a position, the reflective surface 704 may be positioned such that is generally, substantially, or wholly not visible within a field of view of a corresponding image sensor or camera 701 of the vehicle. This may be the position of the reflective surface 704 during movement of the vehicle. Positioning the reflective surface 704 within the body 706 in the second position can protect the reflective surface from damage and clear the reflective surface 704 from the field of view of the image sensor of the camera 701.

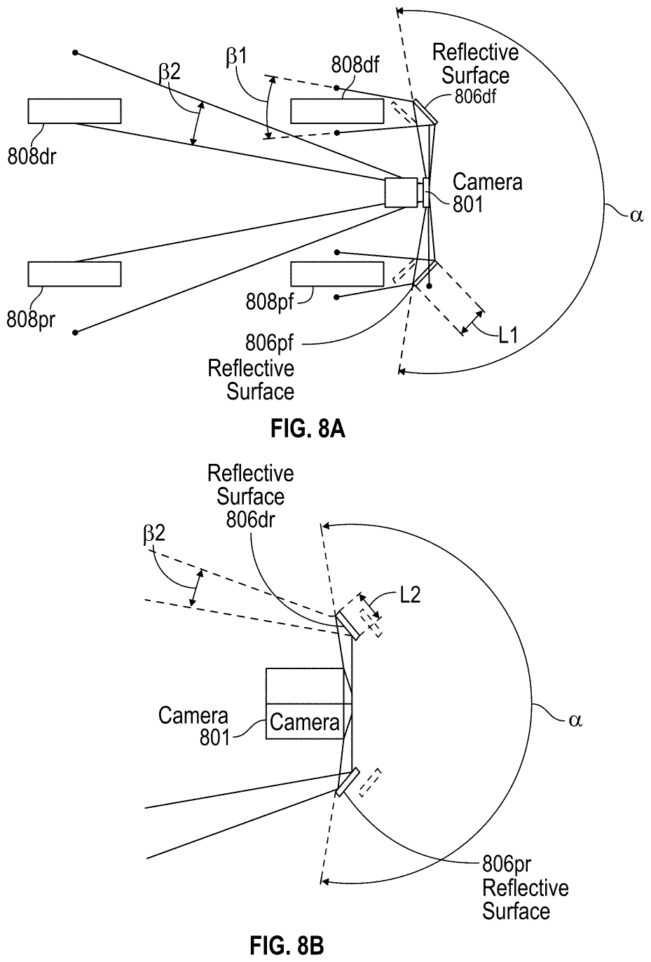

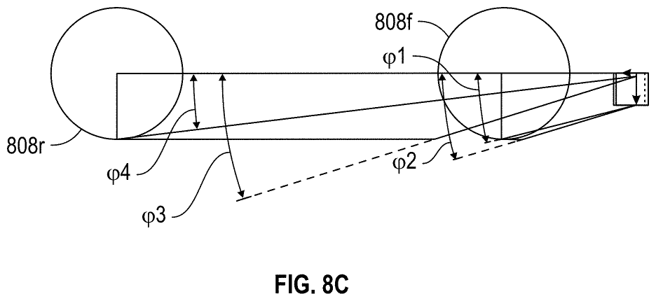

FIG. 8A is a plan view diagram of components of a vehicle including switchable tire view mirror assemblies. The diagram of FIG. 8A illustrates example relative positions of a camera 801, reflective surfaces 806df, 806pf, and wheels 808df, 808pf, 808dr, 808pr. In FIG. 8A, other components of the vehicle (e.g., the body of the vehicle) are omitted for clarity.

The camera 801 can be the same as or similar to front camera 502af or cameras 202a. In the illustrated embodiment, the camera 801 is shown at a position that corresponds to a front region of the vehicle. For example, the camera 801 can be positioned on or in the bumper or other frontal region of the vehicle. The camera 801 can include an image sensor. The camera 801 and the image sensor have a field of view as illustrated by the angle α. In some cases, the angle α can be of approximately or greater than 120 degrees, 150 degrees, 180 degrees, 190 degrees, 200 degrees, 210 degrees, 220 degrees or more, and/or the like. In the illustrated embodiment, the angle α is about 200 degrees. In some cases, the camera 801 can be a wide-angle camera.

As shown, reflective surfaces 806df, 806pf can be positioned (e.g., moved into a position) in which the reflective surfaces 806df, 806pf are positioned with the field of view of the camera 801 (as represented by the angle α). The reflective surfaces 806df, 806pf can thus be associated with a reflective viewing angle β1, which as shown, is positioned such that front wheels 808df, 808pf are positioned therein, thereby allowing the wheels 808df, 808pf (e.g., reflections thereof) to be viewable with the field of view of the camera 801 as represented by the angle α. In some cases, the reflective viewing angle β1 can be, for example, approximately or greater than 5 degrees, 10 degrees, 15 degrees, 20 degrees, 25 degrees, 30 degrees, or more. The reflective viewing angle β1 can be associated with a length L1 of the reflective surfaces 806df, 806pf, as well as the relative positioning of the reflective surfaces 806df, 806pf and camera 801. In some cases, the length L1 can be approximately 200 mm, 220 mm, 240 mm, 280 mm, 300 mm, 320 mm, 340 mm, 360 mm, 380 mm, or 400 mm. In some cases, the length L1 can be shorter or longer than the listed values.

With continued reference to FIG. 8A and with reference to FIG. 8B, example relative positions of reflective surfaces 806dr, 806pr for providing a reflective viewing angle β2 for viewing the rear wheels 808dr, 808pr is illustrated. In some cases, the reflective viewing angle β2 can be, for example, approximately or greater than 5 degrees, 10 degrees, 15 degrees, 20 degrees, 25 degrees, 30 degrees, or more. The reflective viewing angle β2 can be associated with a length L2 of the reflective surfaces 806dr, 806pr, as well as the relative positioning of the reflective surfaces 806dr, 806pr and camera 801. In some cases, the length L2 can be approximately 5 mm, 10 mm, 15 mm, 16 mm, 20 mm, 25 mm, 30 mm, 35 mm, 45 mm, or 60 mm. In some cases, the length L2 can be shorter or longer than the listed values. In the illustrated configuration, the length L2 of the reflective surfaces 806dr, 806pr (associated with viewing rear wheels 808dr, 808pr) can be shorter than the length L1 of the reflective surfaces 806df, 806pf (associated with viewing rear wheels 808df, 808pf) because the reflective surfaces 806dr, 806pr are positioned closer to the camera 801 than the reflective surfaces 806df, 806pf.

FIG. 8C is a side view diagram of components of the vehicle of FIG. 8A including switchable tire view mirror assemblies. In this view example viewing angles φ1, φ2, φ3, φ4 are illustrated, which are associated with minimum and full coverage of the front and rear wheels 808f, 808r.

The configuration and angles illustrated in FIGS. 8A-8C are provided by way of example and should not be construed as limiting. Rather, the camera 801 and the reflective surfaces 806 may be sized and/or positioned so as to be able to provide reflective views of corresponding wheels 808 of the vehicle within the field of view of the camera 801. This may depend on the dimensions of the vehicle, the position of the camera 801, and the positions of the reflective surfaces 806.

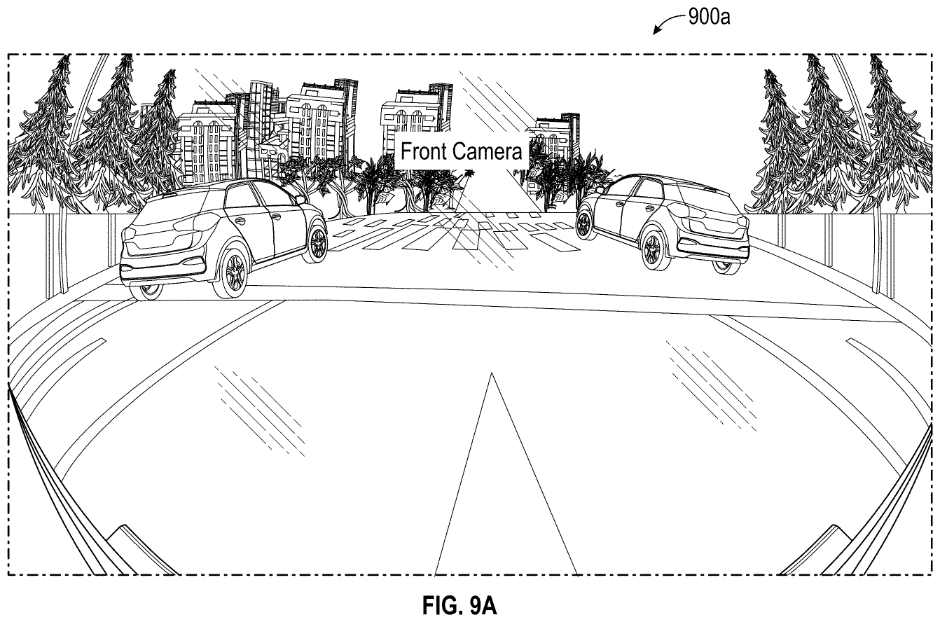

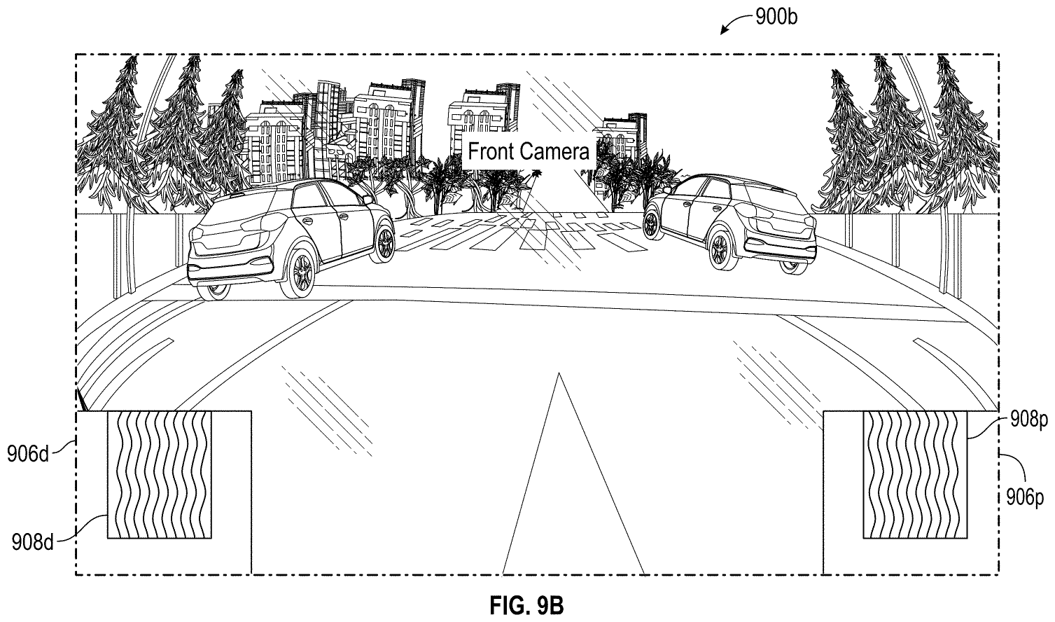

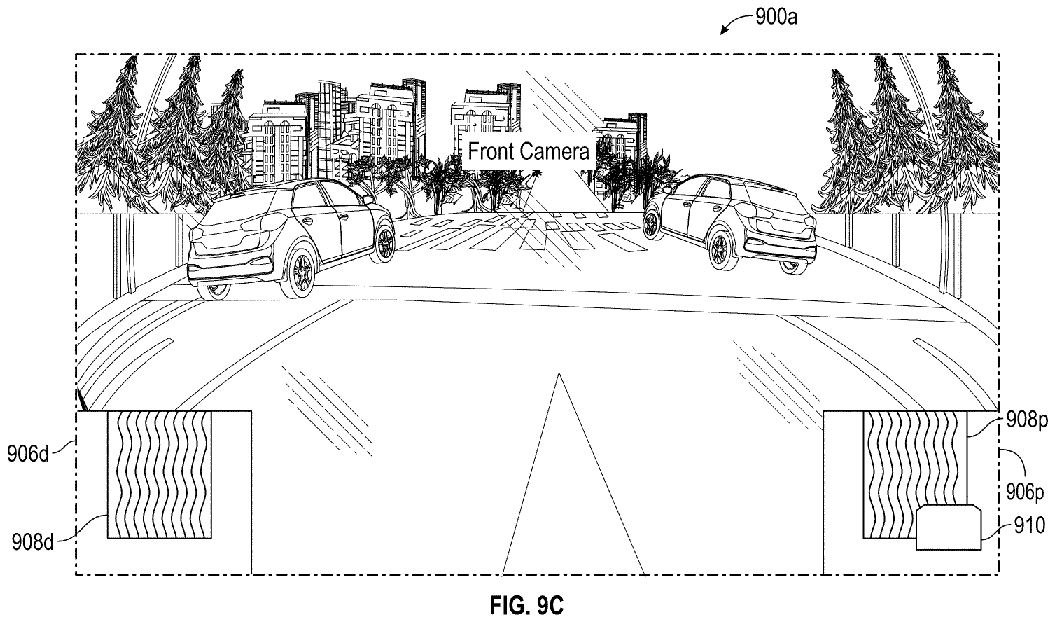

FIG. 9A is an example image 900a captured with an image sensor of a forward-facing camera on a vehicle including switchable wheel view mirror assemblies. The image 900a is representative of an image that may be captured with, for example, the front camera 502af of FIG. 5. It shows a forward-facing view from the perspective of the vehicle. The image 900a is captured with switchable wheel view mirror assemblies in the second position, wherein a reflective surface of switchable wheel view mirror assemblies is not positioned generally or substantially within a field of view of the image sensor. Accordingly, the reflective surface of the switchable wheel view mirror assemblies is not visible in the image 900a.

FIG. 9B is an example image 900b captured with the image sensor of the forward-facing camera of the vehicle of FIG. 9A illustrated with the switchable wheel view mirror assemblies in a deployed position which includes a reflected view of wheels of the vehicle. As shown, reflective surfaces 906 (906d for a driver side reflective surface and 906p for a passenger side reflective surface) are now visible within the image 900b. The reflective surfaces 906 can be the same or similar to any of the reflective surfaces described herein, including reflective surfaces 604, 704, 806. This can be because the reflective surfaces 906 have been moved from the second position (see, e.g., FIGS. 6B and 7B), in which they are generally hidden, to the first position (see, e.g., FIGS. 6A and 7A) in which they are at least partially visible within the field of view of the image sensor and thus appear on the image 900b. Further, FIG. 9B illustrates that the reflective surfaces 906 are positioned so that a reflected view of a wheel 908 (908d for a driver side wheel and 906p for a passenger side wheel) are visible on the reflective surface 906 in the image 900b. This can allow for monitoring of a region around the wheels 908 using a forward-facing camera.

FIG. 9C is an example image captured with the image sensor of the forward-facing camera of the vehicle of FIG. 9A illustrated with the switchable wheel view mirror assemblies in a deployed position which includes a reflected view of an object 910 positioned in front of one of the wheels 908 of the vehicle.

FIGS. 9B and 9C can be representative of the switchable wheel view mirror assemblies configured to provide reflected views of front portions of the front or rear wheels of the vehicle. In some cases, the switchable wheel view mirror assemblies configured to provide reflected views of front portions of the front wheels can appear in a different location on the images 900b, 900c than the switchable wheel view mirror assemblies configured to provide reflected views of front portions of the rear wheels. In other cases, the switchable wheel view mirror assemblies configured to provide reflected views of front portions of the front wheels and the switchable wheel view mirror assemblies configured to provide reflected views of front portions of the rear wheels can appear in the same place in the images 900b, 900c.

FIGS. 9A-9C also present an example from a front-facing camera. Similar images can be produced from a rear-facing camera. In such cases, the switchable wheel view mirror assemblies can be configured to provide reflected views of rear portions of the front or rear wheels of the vehicle. In some cases, the switchable wheel view mirror assemblies configured to provide reflected views of front portions of the rear wheels can appear in a different location on the images 900b, 900c than the switchable wheel view mirror assemblies configured to provide reflected views of rear portions of the rear wheels. In other cases, the switchable wheel view mirror assemblies configured to provide reflected views of rear portions of the front wheels and the switchable wheel view mirror assemblies configured to provide reflected views of rear portions of the rear wheels can appear in the same place in the images 900b, 900c

FIG. 10 is a flowchart of an embodiment of a routine 1000 to control switchable wheel view mirrors. In some cases, the routine 1000 can be implemented or executed by a processor associated with autonomous system 202 (e.g., by autonomous vehicle compute 202f or safety controller 202g), autonomous vehicle compute 400, autonomous system 502 (e.g., by autonomous vehicle compute 502b or safety controller 502c), or other processors or components. In some cases, the processor can execute instructions stored in a non-transitory computer readable media to implement the routine 1000. For simplicity, the routine 1000 will be described as generally being implemented by the autonomous vehicle compute 502b, however, it will be understood that any combination of components of the autonomous system 502 can be used to implement the routine 1000, such as for example, safety controller 506c.

At block 1002, the autonomous vehicle compute 502b causes a reflective surface to move to a first position from a second position, wherein, in the first position, the reflective surface is positioned within a field of view of an image sensor coupled to a vehicle such that a reflected view of at least a portion of a wheel of the vehicle is visible on the reflective surface within the field of view of the image sensor. As described above, the autonomous vehicle compute 502b can send an instruction to an actuator that causes the actuator to move the reflective surface.

At block 1004, the autonomous vehicle compute 502b cause the capture of an image with the image sensor. The image can be an image similar to that shown in FIG. 9B or 9C in which the reflective surface is visible within the image and provides a reflected view of a wheel of the vehicle.

At block 1006, the autonomous vehicle compute 502b analyzes the image to determine a location of an object relative to the wheel of the vehicle. In some cases, block 1006 can include determining whether an object is present in the image at all. If so, the autonomous vehicle compute 502b can determine the location of the object relative to the wheel.

In some cases, the routine 1000 further comprises analyzing the image to determine an object type of the object. This may include a characterization of the object, such as a determination of the size of the object, whether the object will be damaged if struck by the wheel, whether the object will cause damage to the vehicle, etc. In certain cases, the autonomous vehicle compute can use one or more trained neural networks to identify and classify objects in an image.

At block 1008 the autonomous vehicle compute 502b determines whether motion of the vehicle is permitted based on the location of the object relative to the wheel of the vehicle. For example, if the object is positioned in front of the wheel (e.g., as shown in FIG. 9C) such that it would be struck if the vehicle moves, autonomous vehicle compute 502b may prohibit motion of the vehicle until the object is removed. Conversely, if no object is found (e.g., as shown in FIG. 9B) the autonomous vehicle compute 502b may permit the vehicle to move.

In some cases, the autonomous vehicle compute 502b can determine whether to permit motion of the based on the object type. This may include identifying and classifying objects, such as a determination of the size of the object, whether the object will be damaged if struck by the wheel, whether the object will cause damage to the vehicle, etc.

Fewer, more, or different blocks can be used in routine 1000. In addition, the blocks may be performed concurrently or reordered. For example, in some cases, the routine 1000 may further include, based on determining that motion of the vehicle is permitted, causing the reflective surface to move from the first position to the second position. For example, the reflective surface can be moved from the position illustrated in FIG. 7A to that illustrated in FIG. 7B. In the second position, the reflective surface can be at least one of positioned substantially within a body panel of the vehicle or the reflective surface is not visible within the field of view of the image sensor. Further, in some cases, based at least in part on determining that motion of the vehicle is permitted, the autonomous vehicle compute 502b can permit or cause motion of the vehicle. Causing motion of the vehicle can include one of fully autonomous motion of the vehicle, semi-autonomous motion of the vehicle, or human-operated motion (e.g., non-autonomous motion) of the vehicle.

In some cases, based at least in part on determining that motion of the vehicle is not permitted, the autonomous vehicle compute 502b can cause the vehicle to remain stationary. In some cases, based at least in part on determining that motion of the vehicle is not permitted, the autonomous vehicle compute 502b provides an alert that the wheel is obstructed by the object.

In some cases, the autonomous vehicle compute 502b can monitor front portions of front or rear wheels using switchable tire view mirrors configured for use with a forward-facing camera on the vehicle. Additionally or alternatively, the autonomous vehicle compute 502b can monitor rear portions of front or rear wheels using switchable tire view mirrors configured for use with a rearward-facing camera on the vehicle.

FIG. 11 is a flowchart of another embodiment of a routine 1100 to control switchable wheel view mirrors. In some cases, the routine 1100 can be implemented or executed by a processor associated with autonomous system 202 (e.g., by autonomous vehicle compute 202f or safety controller 202g), autonomous vehicle compute 400, autonomous system 502 (e.g., by autonomous vehicle compute 502b or safety controller 502c), or other processors or components. In some cases, the processor can execute instructions which are stored in a non-transitory computer readable media to implement the routine 1100. For simplicity, the routine 1100 will be described as generally being implemented by the autonomous vehicle compute 502b, however, it will be understood that any combination of components of the autonomous system 502 can be used to implement the routine 1000, such as for example, safety controller 506c.

The routine 1100 can include a series of checks that can be performed, for example, prior to permitting movement of a vehicle. At block 1102, an engine of the vehicle is turned on. At block 1104, the autonomous vehicle compute 502b engages (e.g., moves to the extended, deployed or first position) switchable wheel view mirrors (also referred to as switchable tire view mirrors (STVMs)) for monitoring the front wheels, while STVMS for monitoring the rear wheels remain disengaged (e.g., in the retracted, concealed, hidden, or second position). Autonomous vehicle compute 502b captures images and analyzes the images to determine whether any objects obstruct the front wheels. If so, at block 1106, the autonomous vehicle compute 502b causes the vehicle to remain stationary (motion is not permitted) until the obstruction is cleared.

If not, at block 1108, the autonomous vehicle compute 502b disengages the STVMs for monitoring the front wheels (e.g., positions them in the retracted, concealed, hidden, or second position), while STVMS for monitoring the rear wheels are engaged (e.g., moved to the extended, deployed or first position). Autonomous vehicle compute 502b causes the capture of images and analyzes the images to determine whether any objects obstruct the rear wheels. If so, at block 1110, autonomous vehicle compute 502b causes the vehicle to remain stationary (motion is not permitted) until the obstruction is cleared.

If not, at block 1112, autonomous vehicle compute 502b disengages both the STVMs for monitoring the front and rear wheels are disengaged. Autonomous vehicle compute 502b then captures images and analyzes the images to determine whether any objects are positioned around the vehicle that would cause an obstruction. If so, at block 1116, the vehicle remains stationary (motion is not permitted) until the obstruction is cleared. In not, the vehicle is permitted to move at block 1118.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A system for providing a view of at least a portion of one or more wheels of a vehicle, the system comprising:
an image sensor coupled to a vehicle, the image sensor configured to capture an image within a field of view of the image sensor;
a reflective surface; and
an actuator coupled to the reflective surface, the actuator configured to move the reflective surface between a first position and a second position,
wherein in the first position, a view of at least a portion of a wheel of the vehicle is visible within the reflective surface, and the reflective surface is disposed at least partially within the field of view of the image sensor.

2. The system of claim 1, wherein, in the second position, the reflective surface is positioned substantially within a body panel of the vehicle.

3. The system of claim 1, wherein, in the second position, the reflective surface is substantially not visible within the field of view of the image sensor.

4. The system of claim 1, further comprising a wide-angle camera comprising the image sensor.

5. The system of claim 1, wherein the image sensor is mounted on a front portion of the vehicle and configured such that the field of view of the image sensor provides a substantially forward-facing view.

6. The system of claim 5, wherein, in the first position, the at least the portion of the wheel that is visible within the reflective surface comprises a reflected view of at least a front portion of a front wheel of the vehicle.

7. The system of claim 1, wherein the image sensor is mounted on a rear portion of the vehicle and configured such that the field of view of the image sensor provides a substantially rearward-facing view.

8. The system of claim 7, wherein, in the first position, the at least the portion of the wheel that is visible within the reflective surface comprises a reflected view of at least a back portion of a rear wheel of the vehicle.

9. The system of claim 1, wherein the actuator is configured to move the reflective surface between the first position and the second position by at least one of translating the reflective surface or rotating the reflective surface.

10. The system of claim 1, further comprising at least one processor configured to:
cause the actuator to move the reflective surface to the first position,
capture an image with the image sensor, and
analyze the image to determine whether an object is obstructing the wheel of the vehicle.

11. The system of claim 10, wherein the at least one processor is further configured to:
based at least in part on determination that an object is not obstructing the wheel of the vehicle:
cause the actuator to move the reflective surface to the second position, and
enable motion of the vehicle.

12. The system of claim 1, wherein the reflective surface comprises a mirror.

13. A method for selectively viewing at least a portion of a wheel of a vehicle, the method comprising:
causing, using at least one processor, a reflective surface to move to a first position from a second position, wherein, in the first position, the reflective surface is positioned within a field of view of an image sensor coupled to a vehicle such that a reflected view of at least a portion of a wheel of the vehicle is visible on the reflective surface within the field of view of the image sensor; and
capturing an image with the image sensor.

14. The method of claim 13, wherein moving the reflective surface to the first position from the second position comprises actuating an actuator coupled to the reflective surface.

15. The method of claim 14, wherein the actuator is configured to move the reflective surface from the first position to the second position by at least one of translating the reflective surface or rotating the reflective surface.

16. The method of claim 13, further comprising:
analyzing the image to determine a location and an object type of an object relative to the wheel of the vehicle;
determining whether motion of the vehicle is permitted based on the type of the object and a location of the object relative to the wheel of the vehicle.

17. The method of claim of 13, further comprising causing the reflective surface to move from the first position to the second position.

18. The method of claim 17, wherein, in the second position, the reflective surface is at least one of positioned substantially within a body panel of the vehicle or the reflective surface is substantially not visible within the field of view of the image sensor.

19. At least one non-transitory storage media storing instructions that, when executed by at least one processor, cause the at least one processor to:
cause a reflective surface to move to a first position from a second position, wherein, in the first position, the reflective surface is positioned within a field of view of an image sensor coupled to a vehicle such that a reflected view of at least a portion of a wheel of the vehicle is visible on the reflective surface within the field of view of the image sensor;
capture an image with the image sensor; and
analyze the image to determine whether an object is obstructing the wheel of the vehicle.

20. The at least one non-transitory storage media of claim 19, wherein the instructions further cause the at least one processor to:
cause the reflective surface to move from the first position to the second position,
wherein, in the second position, the reflective surface is at least one of positioned substantially within a body panel of the vehicle or the reflective surface is substantially not visible within the field of view of the image sensor
